(19) United States
(12) Patent Application Publication
(10) Pub. No.: US 2025/0137593 A1
(43) Pub. Date: May 1, 2025

(54) MOBILE REFUELING WITH HYDROGEN CASCADE ARCHITECTURE, AND VACUUM CONDITIONING FOR LIQUID HYDROGEN STORAGE SYSTEMS

(71) Applicant: ZeroAvia Ltd, Cirencester (GB)

(72) Inventors: Arnab CHATTERJEE, Cirencester (GB); Aritra DALAL, Cirencester (GB); Parker Bryant, Cirencester (GB); John Edward GALLAGHER, Cirencester (GB)

(21) Appl. No.: 18/927,681

(22) Filed: Oct. 25, 2024

Related U.S. Application Data
(60) Provisional application No. 63/546,146, filed on Oct. 27, 2023.
(60) Provisional application No. 63/546,719, filed on Oct. 31, 2023.

(51) Int. Cl. F17C 5/02

(52) U.S. Cl. CPC F17C 7/04; C23C 22/06; F17C 5/06; F17C 2203/0607; F17C 2203/0646; F17C 2205/0323; F17C 2209/225; F17C 2221/012; F17C 2223/0161; F17C 2223/033; F17C 2223/035; F17C 2225/0123; F17C 2225/036; F17C 2227/0157; F17C 2227/0185; F17C 2227/043; F17C 2250/0626; F17C 2260/02; F17C 2260/021; F17C 2260/025; F17C 2265/065; F17C 2270/0171; F17C 2270/0173; F17C 2270/0189

(57) ABSTRACT

A method and system for mobile storage and dispensing of hydrogen (H₂) for refueling H₂-powered vehicles includes a compressor system having a plurality of compressor stages in fluid communication with at least a portion of manifold valves in locations between compressor stages. A booster compression stage positioned downstream of the compressor system is in fluid communication between at least two of the manifold valves. A plurality of H₂ storage banks is positioned downstream of the compressor system and the booster compressor stage. Low-pressure H₂ is pressurized by the compressor system and/or the booster compressor stage to a working pressure and stored within the H₂ storage banks. Upon a decrease of the H₂ in one or more of the H₂ storage banks from the working pressure, the H₂ is repressurized by the booster compressor stage. Also disclosed is a ground-based cryogenic tank and a method of manufacturing a ground-based cryogenic tank.

### CROSS REFERENCE TO RELATED APPLICATIONS

This application claims benefit to U.S. Provisional patent application Ser. No. 63/546,146, filed Oct. 27, 2023, and U.S. Provisional patent application Ser. No. 63/546,719, filed Oct. 31, 2023, the contents of which are incorporated herein by reference in its entirety

### TECHNICAL FIELD

The present disclosure in one aspect relates to refueling infrastructure and systems for vehicles. The disclosure has particular utility in refueling hydrogen fuel cell aircraft in a manner which decreases refueling time and reduces operating capital of a refueling system, and will be described in connection with such utility, although other utilities such as refueling hydrogen-burning aircraft are contemplated. In another aspect, the present disclosure relates to ground-based cryogenic tank systems, and more particularly to ground-based cryogenic tank systems used with storing hydrogen for hydrogen-powered flight applications, where the active pumping and maintenance timeframes of these cryogenic tank systems can be extended advantageously.

### BACKGROUND AND SUMMARY

This section provides background information which is not necessarily prior art, and which is related to the present disclosure. This section provides a general summary of the disclosure and is not a comprehensive disclosure of its full scope or all its features.

Hydrogen (H₂) fuel cells (FCs) may be used as power sources for H₂-powered motors of electric vehicles and hybrid electric vehicles, including aircraft. In such applications, FCs oftentimes are arranged in stacks of multiple cells and connected in a series or parallel arrangement to achieve a desired power and output voltage. H₂ FC aircraft utilize H₂ storage tanks to store H₂ needed for powering the FCs, where H₂ is transferred to the H₂ FCs during operation to thereby power the propulsion system of the aircraft.

An H₂ FC is an electrochemical cell that converts chemical energy into electrical energy by spontaneous electrochemical reduction-oxidation (redox) reactions. H₂ FCs include an anode and a cathode separated by an ionically conductive electrolyte. During operation, H₂ fuel is supplied to the anode and an oxidant (e.g., oxygen or air) is supplied to the cathode. The H₂ fuel is oxidized at the anode, producing positively charged ions (e.g., H₂ ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and H₂ is exothermic, generating heat that must be removed from the fuel cell.

While H₂ FC-powered aircraft do not utilize fossil fuels required by most conventional aircraft, H₂ FC-powered aircraft still require refueling operations between flights. Refueling an H₂ FC-powered aircraft requires H₂ fuel on the order of thousands of kilograms.

H₂ fuel for flight applications is conventionally stored in subterranean tanks in locations which are readily accessible to aircraft or transport refueling vehicles for aircraft, such as mobile storage and dispensing units. Various systems have been used which involve storing H₂ in a liquified state, which is conventionally achieved by cooling the H₂ to cryogenic temperature ranges. The H₂ may be maintained in the liquefied state by using various thermal insulations and may often utilize multi-walled vessels, such as those with inner and outer walls, as well as optional walls therebetween. The insulative effect on the vessel may also be achieved by generating a vacuum within the vessel, either within the inner storage tank for the H₂ or an outer insulation layer.

Conventional H₂ ground-based cryogenic tank solutions for high vacuum require heavy active pumping and maintenance, such as, for instance, on a monthly or quarterly basis. With the increase of H₂ fuels for flight applications, it is expected that flight application will further tax these tank solutions which is likely to increase the maintenance need on the tanks. For instance, in one example, the periodic maintenance of conventional tanks can be expected to increase to a weekly or monthly timeframe, which is due, at least in part, to environmental characteristics, such as temperature or vibration.

Various solutions have been proposed in the art to further extend operational periods in between maintenance of these tanks. For instance, EP0154165A2 describes a method for adsorbing and storing H₂ at cryogenic temperatures which uses a cryosorption pump for high vacuum using porous carbon. Additionally, US2008/0168776 discloses a H₂ storage tank system based on gas adsorption on high-surface materials which achieves cryogenic H₂ storage with high-surface material and heat exchanger. However, despite these solutions, there is still a need in the industry for ground-based cryogenic tank systems which can meet the expected requirements for the growing H₂ FC-powered aircraft industry.

To improve over these limitations of conventional ground-based cryogenic tank systems for storing liquid hydrogen (LH₂), a synergistic system and method may be used which includes bonding of activated carbon to the outside wall of the cryogenic storage (inner chamber), a bake-out conditioning process of at least the inner chamber, utilizing Non-Evaporable Getter (NEG) technology for passive pumping a vacuum space within a vacuum container (outer chamber), and for aluminum chambers, a conversion coating process.

In one embodiment, bonding of activated carbon to outer wall of the cryogenic storage chamber has been found to dramatically increases the surface area at which cryoadsorption takes place, extending the saturation point and maintaining low pressure for longer periods of time. With activated carbon bonding, one expects maintenance periods on the order of months to a year, rather than weeks to months as seen in conventional tanks.

In conventional systems, water vapor typically requires an external pump to pump out of vacuum, but in another embodiment of the disclosure, the bake-out conditioning process allows water to be removed faster from the vacuum system, enabling a better base pressure. With a bake-out process, one expects a 1⁻⁷ mbar performance, whereas turbo pumping achieves 1⁻⁵ mbar and rotary pumping achieves 1⁻³ mbar.

In yet another embodiment, passive pumping with NEGs eliminates the need for an external pump for majority of chamber gasses, thereby reducing weight, and maintenance may be done in place, reducing maintenance complexity.

In yet another embodiment, for aluminum chambers, conversion coating of the aluminum improves outgassing rate by one or two orders of magnitude to a similar performance level as stainless steel, but with much less weight. In such embodiment, the conversion coating preferably comprises a trivalent chromium liquid coating applied by dipping, wiping or spraying.

The present disclosure can also be viewed as providing methods of manufacturing a ground-based cryogenic tank for storing H₂ fuel. In this regard, one embodiment of such a method, among others, can be broadly summarized by the following steps: bonding an activated carbon to an outside wall of an inner chamber; bake-out conditioning at least the inner chamber; after the inner chamber is positioned within an outer chamber, generating a vacuum within an interior volume of the outer chamber; and passive pumping the interior volume with at least one non-evaporable getter (NEG).

In one aspect, when the inner chamber is formed from aluminum, the method may further include conversion coating the aluminum.

Embodiments of the present disclosure also provide a system for a ground-based cryogenic tank for storing H₂ fuel. Briefly described, in architecture, one embodiment of the system, among others, can be implemented as follows. An inner chamber is configured for storing H₂ fuel in a liquid state. An activated carbon is bonded to an outside wall of at least the inner chamber. At least the inner chamber is bake-out conditioned. An outer chamber has an interior volume, wherein the inner chamber is positioned within the interior volume, wherein a vacuum exists in the interior volume. At least one NEG is used for passive pumping of the interior volume.

In one aspect, when the inner chamber is formed from aluminum, the aluminum is conversion coated. In such aspect, the conversion coating preferably comprises chromium liquid coating applied by dipping, wiping, or spraying.

The present disclosure can also be viewed as providing methods of manufacturing a ground-based cryogenic tank for storing H₂ fuel. In this regard, one embodiment of such a method, among others, can be broadly summarized by the following steps: manufacturing an inner chamber from aluminum; manufacturing an outer chamber having an interior volume; conversion coating at least the aluminum of the inner chamber; bonding an activated carbon to an outside wall of the inner chamber; bake-out conditioning the inner and outer chambers; positioning the inner chamber within an interior volume of an outer chamber; generating a vacuum within the interior volume of the outer chamber; and passive pumping the interior volume with at least one NEG.

In another aspect of the disclosure there is provided a mobile storage and dispending system for refueling H₂ FC-powered vehicles including aircraft. Mobile storage and dispensing (MSD) units exist for refueling H₂ FC-powered aircraft, and they may include, for instance, a skid-mounted H₂ refueling dispenser along with a delivery trailer capable of holding H₂ container units. These existing MSD units only carry approximately 100 kg of H₂ at a time, whereas H₂ FC-powered aircraft may typically require approximately 1,000 kg of H₂ fuel during refueling. The discrepancy between the limited capacity of the MSD and the refueling requirements of H₂ FC-powered aircraft leads to long refuel times and expensive back-and-forth operation, since the MSD will need to make multiple trips between the aircraft and the H₂ source.

Additionally, existing mobile H₂ refuelers are also only capable of accepting H₂ from sources above their operating pressure, which adds engineering complexity for the H₂ supplier operating pressure.

To improve over these limitations of conventional H₂ MSD units, a modular MSD unit having a compression booster stage is disclosed. In one example, the modular MSD unit can carry a 1000 kg target H₂ per lift by using cascade filling from multiple banks with a gas booster to maximize the amount of gaseous H₂. An onboard H₂ management system uses smart cascade and repressurization logic to increase the accessible H₂ volume and is inlet pressure agnostic.

In one embodiment, the novel MSD design maximizes the usable H₂ and reduces the operating capital, e.g., from the ullage H₂ that must be carried, and allows for complete refills and decreased refill time. This leads to a significantly faster refuel time compared to conventional refueling systems currently available in the market. This novel MSD design may have heightened benefits for refueling aircraft quickly in between flights.

In one embodiment, the novel MSD design enables rapid H₂ transfer to the aircraft on the order of 1000 kg by minimizing the ullage H₂ within the MSD through the use of interbank H₂ transfers to increase the pressure in a single or multiple banks.

In another embodiment, the novel MSD design decreases the number of MSD refilling events required for aircraft refueling which will reduce the miles driven, time on non-value-added tasks (driving) and by extension the CO2 emissions associated with the MSD tractor.

In yet another embodiment, the novel MSD design decreases refilling time from a partially filled MSD refueling.

In another embodiment, the novel MSD design lowers operational costs with fast back-to-back operations and operations on-site. It may also lower costs by avoiding fixed infrastructure obligations such as concrete pads and fixed utility connections. This may also act to expedite local permitting processes.

In yet another embodiment, the novel MSD design enables refueling of aircrafts on the apron without an external power connection because of fill to protocol target SoC (state of charge) on back-to-back fills with cascade architecture, compressor on-board for 350 bar refueling.

In another embodiment, the novel MSD design combines storage of H₂, allowing multiple fills, e.g., up to 8 fills, in one example, of aircrafts operating on gaseous H₂ management systems and therefore reduces the number of nodes needed to transfill H₂ across the supply chain.

In yet another embodiment, the novel MSD design allows for scalability through a modularized system, resulting in cost control and interoperability between MSD units.

In another embodiment, the novel MSD design enables the MSD to be inlet pressure agnostic via a manifold design, opening the marketplace for H₂ producers. This may allow the novel MSD to lift from any outlet pressure by virtue of the control system and compressor on board without requiring a supply panel within the producer and the MSD's boundary limits.

Embodiments of the present disclosure also provide a system and method for mobile storage and dispensing system for refueling H₂ FC-powered vehicles. Briefly described, in architecture, one embodiment of the system, among others, can be implemented as follows. A manifold is configured to receive H₂, wherein the manifold has a plurality of valves. A compressor system has a plurality of compressor stages, wherein the compressor system is in fluid communication with at least a portion of the plurality of valves of the manifold in locations between the compressor stages. A booster compression stage is positioned downstream of the compressor system and is in fluid communication between at least two of the plurality of valves of the manifold. A plurality of H₂ storage banks is positioned downstream of the compressor system and the booster compressor stage. Low-pressure H₂ is pressurized by at least one of the compressor system or the booster compressor stage to a working pressure and stored within one or more of the H₂ storage banks. Upon a decrease of the H₂ in one or more of the H₂ storage banks from the working pressure, the H₂ is repressurized by the booster compressor stage.

In one aspect, the plurality of H₂ storage banks are sized to carry substantially 1000 kg of H₂.

In another aspect, the H₂ is repressurized by the booster compressor stage and consolidated into one or more of the H₂ storage banks.

In yet another aspect, the H₂ received at the manifold is substantially 20 bar, and wherein the working pressure of the H₂ is greater than 350 bar.

In another aspect, a pressure of the H₂ in the compressor system is substantially 400 bar, and the pressure of the H₂ in the booster compression stage is substantially 720 bar.

In yet another aspect, at least one pressure sensor is positioned to sense a pressure of H₂ in the plurality of H₂ storage banks.

In another aspect, the plurality of H₂ storage banks further comprises at least three H₂ storage banks, wherein the three H₂ storage banks are operated to distribute charge-discharge cycles with one of the H₂ storage banks being a swing bank providing intermediate pressure.

In yet another aspect, the manifold is inlet pressure agnostic.

In another aspect, the H₂ storage banks further comprise different H₂ tank sizes.

In yet another aspect, the manifold optimizes energy usage of the compressor system and booster compression stage by routing inlet H₂ gas to a particular compressor stage or the booster compression stage, thereby minimizing a pressure letdown across a pressure regulator.

The present disclosure can also be viewed as providing methods of refueling H₂ FC-powered vehicles with a mobile storage and dispensing system. In this regard, one embodiment of such a method, among others, can be broadly summarized by the following steps: receiving low-pressure H₂ at a manifold, wherein the manifold has a plurality of valves; increasing a pressure of the received H₂ in a compressor system having a plurality of compressor stages, wherein the compressor system is in fluid communication with at least a portion of the plurality of valves of the manifold in locations between the compressor stages; increasing the pressure of the received H₂ from the compressor system in a booster compression stage positioned downstream of the compressor system, wherein the booster compression stage is in fluid communication between at least two of the plurality of valves of the manifold; and storing H₂ pressurized to a working pressure within a plurality of H₂ storage banks positioned downstream of the compressor system and the booster compressor stage, whereby, upon a decrease of the H₂ in one or more of the H₂ storage banks from the working pressure, the H₂ is repressurized by the booster compressor stage.

In one aspect, the plurality of H₂ storage banks are sized to carry substantially 1000 kg of H₂.

In another aspect, repressurization of the H₂ by the booster compressor stage further comprises consolidation of the H₂ into one or more of the H₂ storage banks.

In yet another aspect, the H₂ received at the manifold is substantially 20 bar, and wherein the working pressure of the H₂ is greater than 350 bar.

In another aspect, the pressure of the H₂ in the compressor system is substantially 400 bar, and the pressure of the H₂ in the booster compression stage is substantially 720 bar.

In yet another aspect, the method includes sensing the pressure of H₂ in the plurality of H₂ storage banks with at least one pressure sensor.

In another aspect, the plurality of H₂ storage banks further comprises at least three H₂ storage banks, further comprising operating the three H₂ storage banks to distribute charge-discharge cycles with one of the H₂ storage banks being a swing bank providing intermediate pressure.

In yet another aspect, the manifold is inlet pressure agnostic.

In another aspect, the H₂ storage banks further comprise different H₂ tank sizes.

In yet another aspect, the method includes optimizing energy usage of the compressor system and booster compression stage, by the manifold, by routing inlet H₂ gas to a particular compressor stage or the booster compression stage, thereby minimizing a pressure letdown across a pressure regulator.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings, wherein like numerals depict like parts. The drawings described herein are for illustrative purposes only of selected embodiments and not all possible implementations and are not intended to limit the scope of the present disclosure.

In the drawings:

FIG. 1 is a diagrammatic illustration of a system for a ground-based cryogenic tank for storing H₂ fuel, in accordance with the present disclosure;

FIG. 2 is a diagrammatic illustration of NEG-based pumping used with the system for a ground-based cryogenic tank for storing the H₂ fuel of FIG. 1, in accordance with the present disclosure;

FIG. 3 is a diagrammatic illustration of NEG configuration options which can be used with the system for a ground-based cryogenic tank for storing H₂ fuel of FIG. 1, in accordance with the present disclosure;

FIG. 4 is a flowchart illustrating a method of bonding carbon and preparing an inner chamber used with a method of manufacturing a ground-based cryogenic tank for storing H₂ fuel, in accordance with the present disclosure;

FIG. 5 is a flowchart illustrating a bake-out process used with the method of manufacturing a ground-based cryogenic tank for storing H₂ fuel, in accordance with the present disclosure;

FIG. 6A is a side elevational view of the ground-based cryogenic tank system of FIG. 1, carried on a truck;

FIG. 6B is a side elevational view of the ground-based cryogenic tank system of FIG. 1, carried on a rail car;

FIG. 6C is a side elevational view of the ground-based cryogenic tank system of FIG. 1, carried on a ship;

FIG. 7 is a block diagram illustration of an MSD system for refueling H₂-powered vehicles, in accordance with the present disclosure;

FIG. 8 is a flow diagram illustration of process logic of the MSD system for refueling H₂-powered vehicles, in accordance with the present disclosure;

FIG. 9 is a schematic illustration illustrating details of a manifold and inputs of the MSD system for refueling H₂-powered vehicles, in accordance with the present disclosure;

FIG. 10 is a schematic illustration illustrating details of a compressor system of the MSD system for refueling H₂-powered vehicles, in accordance with the present disclosure;

FIG. 11 is a schematic illustration illustrating details of a H₂ storage system of the MSD system for refueling H₂-powered vehicles, in accordance with the present disclosure;

FIG. 12 is a schematic illustration illustrating details of a H₂ outlet system of the MSD system for refueling H₂-powered vehicles, in accordance with the present disclosure;

FIG. 13 is a schematic illustration illustrating details of a venting system of the MSD system for refueling H₂-powered vehicles, in accordance with the present disclosure; and

FIG. 14 is a flowchart illustrating a detailed method of refueling H₂-powered vehicles with a mobile storage and dispensing system, in accordance with the present disclosure.

### DETAILED DESCRIPTION OF THE INVENTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein “ground-based cryogenic tank systems” may include fixed location tank systems, as well as bulk transportation tank systems including tank trucks, railway tank cars, and tanker ships.

As used herein “H₂-powered vehicles” may include both H₂-burning powered vehicles and H₂ FC-powered vehicles.

As used herein “vehicle” may include land-based vehicles including rail vehicles, water vehicles and flying vehicles including winged airplanes, helicopters and rockets.

To improve over the shortcomings in the industry, the present disclosure in one aspect is directed to methods and systems for a ground-based cryogenic tank to store H₂ fuel, which can provide reduced convection/conduction heat loads, weight, outgassing, and maintenance needs when compared to conventional fuel storage tanks. The methods and systems of this disclosure may primarily be used in a H₂ gas storage system design that combines four aspects which support each other synergistically, although in some situations, less than four of those aspects may be required.

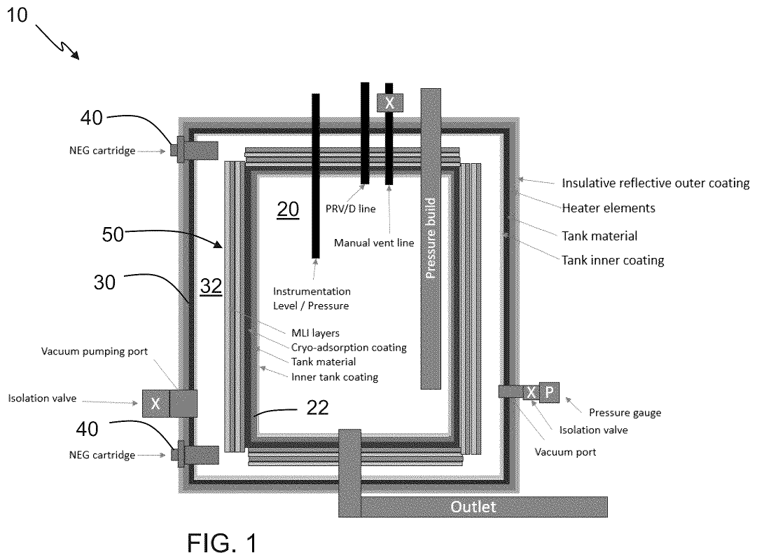

FIG. 1 is a diagrammatic illustration of system 10 for a ground-based cryogenic tank for storing H₂ fuel, in accordance with the present disclosure. In particular, FIG. 1 depicts a cross-sectional view of an example of a cryogenic storage system with the novel combination of the four aspects implemented. The inner tank is identified as the inner chamber 20, and the outer tank is identified as the outer chamber 30. The layers between the inner and outer chambers 20, 30, which are identified as 50, are layers of aluminum and Kapton multi-layer insulation (MLI).

As shown in FIG. 1, the inner chamber 20 is a cryogenic confinement vessel or container which is configured for storing H₂ fuel in a liquid state. The outside wall 22 of the inner chamber 20, e.g., an outer or exterior surface of the wall 22, is bonded with activated carbon. Bonding of activated carbon to outer wall 22 of the cryogenic storage inner chamber 20 dramatically increases the surface area at which cryoadsorption takes place, extending the saturation point and maintaining low pressure for longer periods of time. With activated carbon bonding, maintenance periods on the order of months to a year, rather than weeks, may be achievable. While activated carbon has been used in cryopumps or in cryogenic storage systems to capture some water vapor, system 10 uses activated carbon which is bonded to the surface of at least the outer wall 22 of the inner chamber 20. In this bonded use, the activated carbon may extend the saturation point.

At least the inner chamber 20 is bake-out conditioned, which allows water to be removed faster from the vacuum system, enabling a better base pressure than conventional systems, where water vapor typically requires an external pump to pump out of vacuum. With the bake-out conditioning process, it can be expected to achieve a 1⁻⁷ mbar performance, whereas turbo pumping achieves 1⁻⁵ mbar and rotary pumping achieves 1⁻³ mbar. It is noted that bake-out conditioning is not typically done in cryogenic storage because they are not high-vacuum systems (better than 10⁻⁵ mbar). Existing ground-based systems have no strong need for longevity and use pumps (10⁻³ mbar). For flight systems, it is desirable to have a high-vacuum system of 10⁻⁶ mbar or better, which extends the period of time where maintenance on the system is required. For instance, while conventional systems may require maintenance in a time period measured by weeks or a month or two, the system 10 may have a significantly longer maintenance time period of a minimum of months, e.g. 3+ months, and likely up to a year, or longer. Thus, system 10 effectively buys more time for maintenance, which in turn decreases downtime and maintenance costs. Further, the bake-out process may improve heat loss characteristics at lower pressures.

In addition to post manufacturing cleaning to vacuum grade levels and adhering to good vacuum practice to prevent cross contamination of outgassing sources, additional techniques and steps may be used to improve the bake-out process. For instance, the outer wall 22 of the inner chamber 20 may be at cryogenic temperatures when cryogens are in the tank (when outgassing matters) and, therefore, is a cryogenic pump. The use of the bonding of activated carbon to the outside wall 22 of the inner chamber 20 is to bond baked charcoal or other massive surface area material to improve saturation capacity. Any equipment which lives in the vacuum envelope (e.g. MLI, sensors, probes) may be suitably vacuum baked and outgassed to <1% deviation from linearity as measured using Temperature Controlled Quartz Crystal Microbalance (TQCM) while in bake. The vacuum envelope chamber and pipework may be vacuum baked and outgassed to <1% deviation from linearity as measured using TQCM while in bake.

When the inner chamber 20 or the outer chamber 30 is formed from aluminum, the aluminum may be conversion coated to improve outgassing rate by one or two orders of magnitude to a similar performance level as stainless steel, but with much less weight. In one example, the inner surfaces (vacuum facings) of the aluminum vessels may go through a conversion coating process, in a bath of Surtec 650V™ liquid coating, which is a trivalent chromium passivation coating available from Trimite Global Coatings, Ltd., Redditch, UK, which reduces the outgassing load when exposed to vacuum. The Surtec 650V™ liquid coating is applied by dipping, wiping or spraying. Conversion coating the entire tank also yields the same benefit to the inner surfaces.

An outer chamber 30 is provided, and it has an interior volume 32 in which the inner chamber 20 is positioned. During manufacture, when the inner chamber 20 is positioned within the interior volume 32 of the outer chamber 30, a vacuum is formed within the interior volume 32, thereby placing the inner chamber 20 under the vacuum. At least one NEG device 40 is used for passive pumping of the interior volume. Getters may be classified by the way the clean surface is obtained, and generally include in situ deposition of a fresh getter film (under vacuum), which is referred to as ‘Getters’, and diffusion of the oxide layer into the bulk (usually by heating in vacuum) which is referred to as ‘Non-Evaporable Getters’. Passive pumping with NEGs 40 eliminates the need for an external pump for the majority of chamber gasses, thereby reducing weight, and maintenance may be done in place, reducing maintenance complexity. Conventionally, NEGs have not been used before for cryotanks, but they have been found to be useful because they can only be used at such low pressures, because they are light weight in nature, and because they require no power once activated.

In one example, a typical conditioning operation of the embodiment is described in the following sequence:
1. Mechanical pumping hardware is connected to an open isolation valve;
2. Mechanical pumping removes air and starts to remove small amounts of water vapor;
3. Heater element(s) warms an outer vessel;
4. Heated nitrogen gas is input to an inner tank;
5. Water vapor removal is greatly accelerated by heating elements & heated nitrogen;
6. After approximately 24 hours at 100° C., nearly all water vapor is removed, wherein Lower temperature=longer time, 80° C. for 48 hours or 70° for 72 hours;
7. NEG cartridge starts to activate by heating (plug in power supply to cartridge);
8. Then tanks begin cooling (by regulating the heating elements of the outer chamber and the heated nitrogen gas);
9. Then the NEG cartridge begins cooling (slower rate than vessels, rate dependent on system mechanical properties and heating method), wherein the NEG is fully activated when cooled to ambient temperature, and
10. The isolation valve is closed when the vessels are cooled to ˜40° C.

In further detail of the passive pumping process, it is noted that NEGs 40 are used in accelerator complexes and have an immense H₂ pumping capacity, as well as pumping other chemically-reactive molecules (N₂, O₂, CO, etc.). NEGs 40 typically come in four forms, including coating of pipes, flanged cartridge, wafer modules with electrical feedthrough, and coated on metallic ribbon. NEGs 40 may passively pump H₂, alleviating H₂ permeation. They may also pump gas-load coming off the ambient wall. NEGs 40 pump any release from the cryopumped surface once the tank empties of cryogen, warming the inner wall. NEGs 40 require a well-conditioned (baked interspace) and are activated by heating followed by cooling to ambient temperature. In order to heat the NEG 40, a power supply is usually connected, but the power supply and connection may be removed once the NEG 40 is activated so there is no additional mass or power demand to the system thereafter.

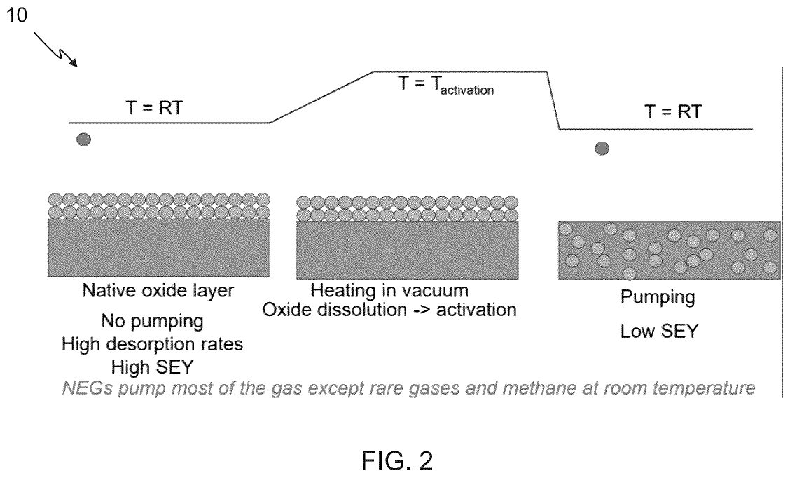

When using NEGs 40, the surface must be clean. For NEGs, a clean surface is obtained by heating to a temperature high enough to dissolve the native oxide layer into the bulk. The Ti—Zr—V NEG coating may be activated at 180° C. for 24 hours. FIG. 2 is a diagrammatic illustration of NEG-based pumping used with the system 10 for a ground-based cryogenic tank for storing H₂ fuel of FIG. 1, in accordance with the present disclosure. As shown, the native oxide layer is present prior to activation. During the ramp up to activation temperature, the native oxide layer is still present. During the plateau at activation temperature, the oxide layer dissolves into the material bulk, leaving a pumping surface for gas loads with the exception of Methane and noble gases.

It is noted that the vacuum may be created by installing a vacuum pumping system to an interface on the vacuum envelope. The interface may be sized such that conductance is maximized in proportion to the conductance within the vacuum envelope (minimum DN25, more commonly DN40, DN63). The performance of the pumping system may be appropriate for the base pressure requirements and the conductance of the system (i.e., balances conductance and matching pumping hardware). The system 10 may feature an oil free roughing/backing pump, Helium leak detector interface and suitable isolation valve, a turbo molecular pump and inlet isolation valve and pressure gauges. The system 10 may be actively pumped for a minimum of several days to week/s to reduce water vapour load or have the ability to heat the vacuum envelope walls and reduce pumping time to ˜36 hours depending on temperature profile. Helium leak checking may be performed before and after baking. Once the leak rate is acceptable and a desired pressure (sufficiently close to the basc pressure) is achieved, the pumping may be isolated and the system held at static vacuum with pressure monitoring using a cold cathode gauge, capacitance monometer or other gauge type, except hot filament gauges, which increase the outgassing load.

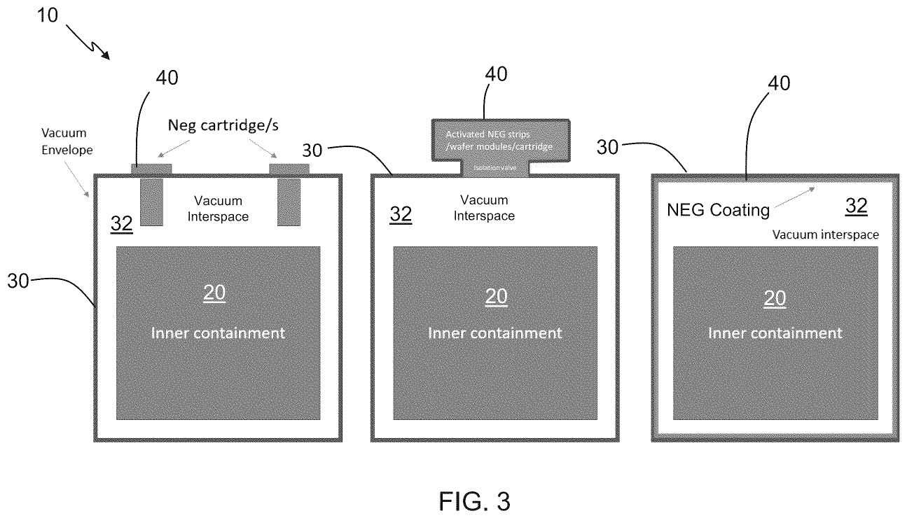

In the example of tank system 10 in FIG. 2, the implementation of passive pumping via NEGs is depicted as using an NEG cartridge. In other examples, NEG wafer modules or a NEG coating may be used. FIG. 3 is a diagrammatic illustration of NEG configuration options which can be used with the system for a ground-based cryogenic tank for storing H₂ fuel of FIG. 1, in accordance with the present disclosure. Specifically, FIG. 3 illustrates three exemplary NEG configuration options, including NEG cartridges (left), NEG wafer modules (center), and NEG coatings (right). All types of NEG configurations, including those discussed relative to FIGS. 1-3, may be useable with the system and method as disclosed herein, but NEG cartridges are used in the example implementation provided relative to FIG. 1.

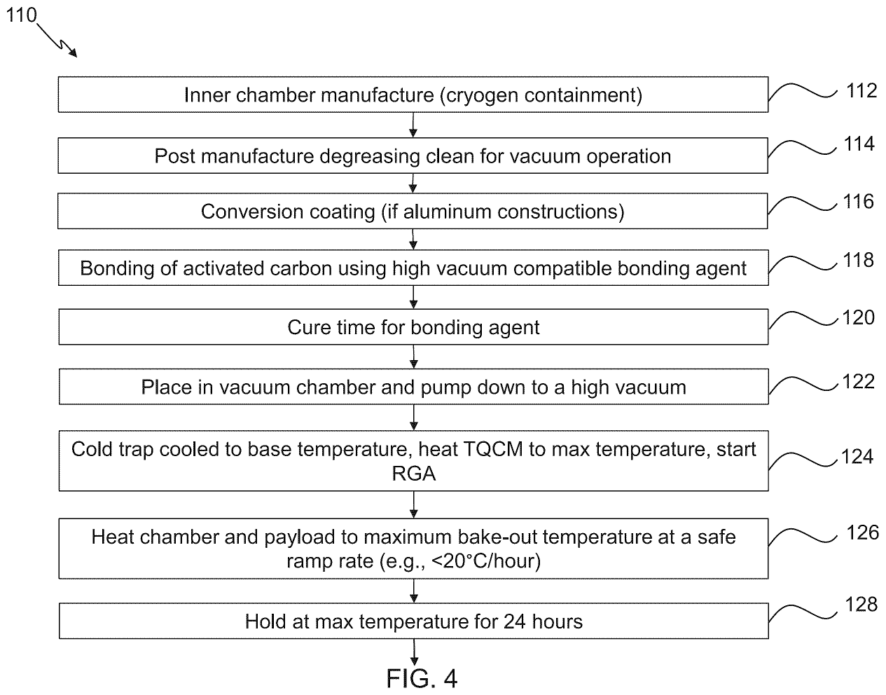

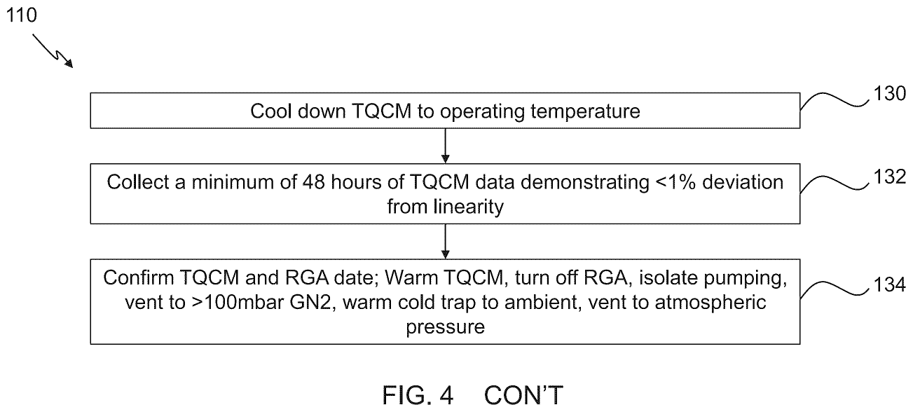

FIG. 4 is a flowchart 110 illustrating a method of bonding carbon and preparing an inner chamber used with a method of manufacturing a ground-based cryogenic tank for storing H₂ fuel, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 112, inner chamber (cryogen containment) is manufactured. A post-manufacture degreasing clean is performed for vacuum operations (block 114). If the container is formed from aluminum, a conversion coating process is performed (block 116). Bonding of activated carbon is performed, which uses a high vacuum compatible bonding agent (block 118). The bonding agent is cured for a period of time (block 120). The container is placed in a vacuum chamber and pumped down to a high vacuum (block 122). The container is cold trap cooled to a base temperature, and heated to TQCM to a max temperature, and Residual Gas Analysis (RGA) is started (block 124). The heat chamber and payload are heated to a maximum bake-out temperature at a safe ramp rate (e.g., <20° C./hour) (block 126). The max temperature is held for 24 hours (block 128). A cool down process of the TQCM is performed to operating temperature (block 130). A minimum of 48 hours of TQCM data is collected to demonstrate <1% deviation from linearity (block 132). TQCM and RGA date are confirmed, TQCM is warmed, RGA is stopped to conform, pumping is isolated, venting to >100 mbar GN2 is achieved, warm cold trap to ambient, and vent to atmospheric pressure is performed (block 134). Any number of additional steps, functions, processes, or variants thereof may be included in the method, including any disclosed relative to any other figure of this disclosure.

It is further noted that carbon derived from coconuts is often used to massively increase the surface area at which cryoadsorption may take place, which increases the saturation duration. Other high-surface materials, such as metal organic frameworks (MOFs) and zeolites, may be used as suitable for cryoadsorption. High-surface materials may be in the form of pellets, powders, or other suitable configurations as understood in the art.

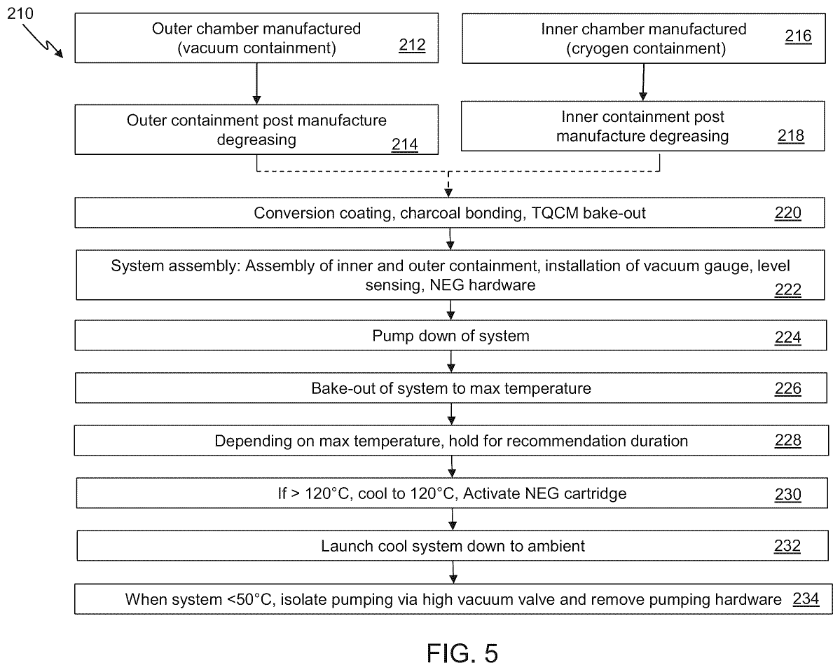

FIG. 5 is a flowchart 210 illustrating a bake-out process used with the method of manufacturing a ground-based cryogenic tank for storing H₂ fuel, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

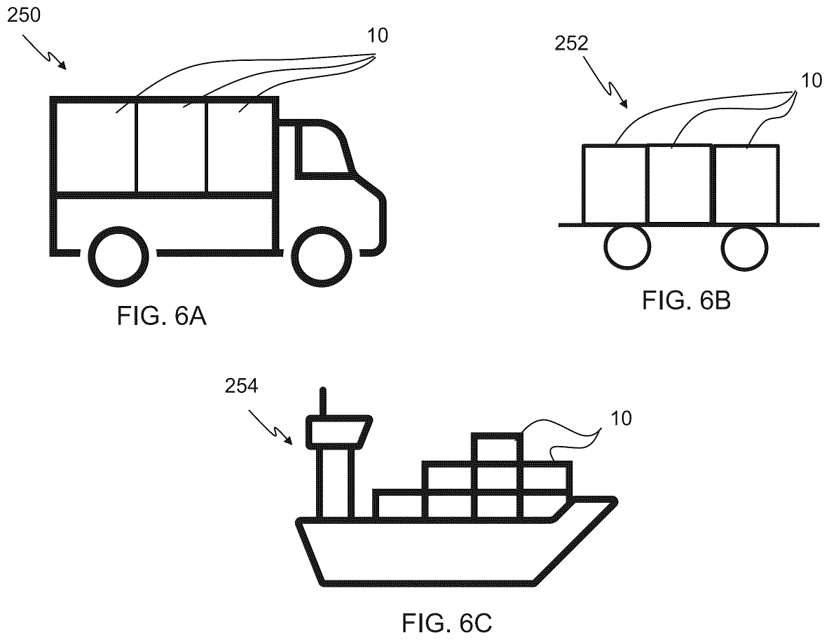

Various changes may be made in the foregoing description without departing from the spirit and scope thereof. For example, the ground-based cryogenic tank system 10 may be carried on a truck 250 (FIG. 6A) or carried on a rail car 252 (FIG. 6B) or carried on a ship 254 (FIG. 6C).

As is shown by block 212 of FIG. 5, the outer chamber or vacuum containment is manufactured, and this chamber is processed through a post-manufacture degreasing (block 214). The inner chamber or cryogen containment is manufactured at block 216 and it is processed through a post-manufacture degreasing (block 218). Conversion coating, charcoal bonding, TQCM bake-out processes on both chambers are performed at block 220. System assembly is performed at block 222, which may include assembly of inner and outer containment, installation of vacuum gauge, level sensing, and NEG hardware. At block 224, the system is pumped down, and a bake-out of the system to a maximum temperature is done at block 226. Depending on the max temperature, the temperature may be held for recommended duration (block 228). At block 230, if the temperature is greater than 120° C., it may be cooled to 120° C., and then the NEG cartridge(s) is activated. The system is cooled down to ambient temperature (block 232) and when the system is less than 50° C., isolate pumping is done via high vacuum valve and pumping hardware is removed (block 234). Any number of additional steps, functions, processes, or variants thereof may be included in the method, including any disclosed relative to any other figure of this disclosure.

In further detail, to prepare a cryogenic storage tank for a bake-out conditioning process, various steps may be required or optionally taken. For instance, the elastomer seals may be removed and replaced with metallic seals, protecting the conditioning once achieved, and to not compromise or ingress water vapor through maintenance activities. Pumping ports may be optimized with regards to conductance (i.e., balancing optimizing pumping hardware, achieving a particular base pressure, minimizing pump down time, and minimizing thermal losses). This includes sizing the turbo pump that is integrated during the pumping/baking phase, and conductances throughout the system to ensure the gas loads may find their way easily out of the system. A greater consideration for cleanliness may be employed through manufacturing and through the lifecycle of the product, including using chemicals/detergents/solvents for degreasing post manufacture and control environmental and process parameters to protect the cleansed hardware. A high-vacuum compatible isolation valve may be included in the system, as opposed to a more simplistic isolation valve, which may be conventionally used.

In another aspect, the present disclosure is directed to methods and systems for mobile storage and dispensing of H₂ for refueling H₂-powered vehicles. This novel MSD unit has a compression booster stage which allows, in one example, for the mobile platform to carry a 1000 kg target H₂ per lift by using cascade filling from multiple banks with a gas booster to maximize the amount of gaseous H₂. An onboard H₂ management system may use smart cascade and repressurization logic to increase the accessible H₂ volume and is inlet pressure agnostic. This novel MSD design maximizes the usable H₂ and reduces the operating capital, e.g., from the ullage H₂ that must be carried, and allows for complete refills and decreased refill time. This leads to a significantly faster refuel time compared to conventional refueling systems currently available in the market. This novel MSD design may have heightened benefits for refueling aircraft quickly in between flights.

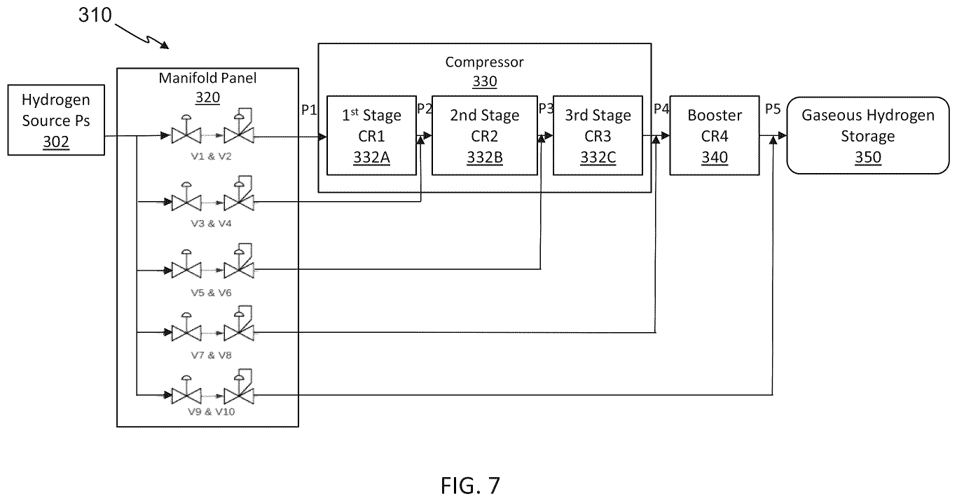

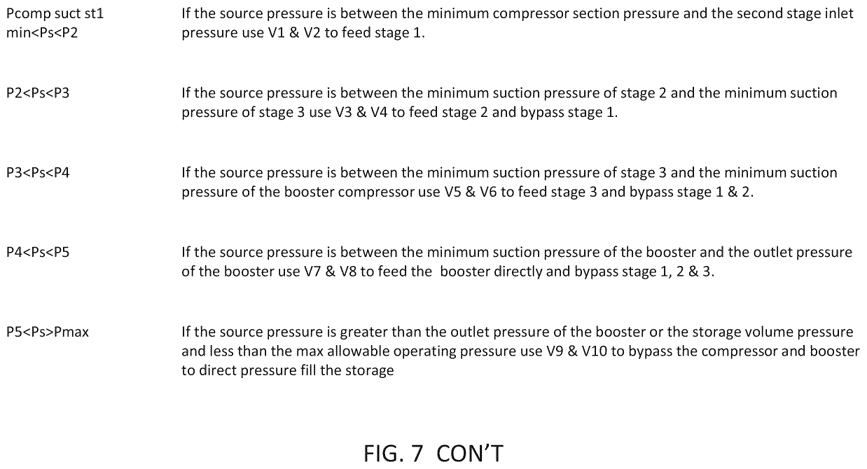

FIG. 7 is a block diagram illustration of a mobile storage and dispensing system 310 for refueling H₂-powered vehicles, in accordance with the present disclosure. The system 310 includes manifold 320 configured to receive H₂ from inlet H₂ source 302. Manifold 320 has a plurality of valves (V1 through V10) which are in fluid communication with H₂ source 302 and receive H₂ at a source pressure (Ps) provided by inlet H₂ source 302. The source pressure (Ps) of the H₂ is a low-pressure production source, which is typically operated substantially at 20 bar.

A compressor system 330 has a plurality of compressor stages 332A-332C which are each in fluid communication with at least a portion of the plurality of valves (V1-V10) of manifold 320 in locations between the compressor stages 332A-332C. For instance, V1 and V2 may feed to an inlet side of compression stage 332A, while V3 and V4 feed to an inlet of compression stage 332B, while V5 and V6 feed to an inlet of compression stage 332C. In this manner, low-pressure H₂ from source 302 can be fed in series to various stages of the compressor system 330. It is noted that any number of compression stages may be used, and any number of valves from manifold 320 may feed the compression stages 332A-332C in any configuration.

A booster compression stage 340 is positioned downstream of compressor system 330, e.g., in a direction corresponding to a flow of the H₂ from source 302 through system 310. The booster compression stage 340 may be a gas booster to maximize the amount of gaseous H₂ which the system 310 can output at a particular pressure. As shown, the booster compression stage 340 is in fluid communication between at least two of the valves of manifold 320, e.g., downstream of the fluid connection to V7 and V8 and upstream of the fluid connection to V9 and V10.

A plurality of H₂ storage banks 350 is positioned downstream of compressor system 330 and booster compressor stage 340, whereby the banks 350 receive pressurized H₂ that has moved through the system 310, such that the pressurized H₂ can be output into H₂ FC aircraft during a refueling procedure. During a refueling operation, system 310 pressurizes H₂ from low pressure of approximately 20 bar with compressor system 330 and booster compressor stage 340 to achieve a working pressure of the H₂ which is stored within H₂ storage banks 350. Upon a decrease of the H₂ pressure in the working pressure level from one or more of the storage banks 350, such as from a discharge of H₂ into an aircraft, the H₂ is repressurized by booster compressor stage 340 to thereby maintain the working pressure within one or more of the banks 350.

In greater detail, system 310 may lift H₂ from the low-pressure production source 302, which may be a Proton Exchange Membrane (PEM) electrolyzer operating at 20 bar. The inlet pressure sensor detects the inlet pressure being less than the desired working pressure or storage pressure, e.g., P (H₂ inlet)<P (storage pressure), and activates compressor 330 and booster compression stage 340. The compression ratio (CR) of the compressor 330 may be, in one example, 20:1, resulting in a pressure of 400 bar before the H₂ stream is fed to the suction side of the booster 340. The booster 340 has a CR of 1.8:1, in one example, with a final discharge pressure of 720 bar. This provides the mode of force to pressurize the storage bank 350 to a working pressure, such as at 500 bar or another pressure that is typically above 350 bar. The working pressure setpoint may be determined from the controls interface to be either the maximum allowable working pressure (MAOP) or the user defined setpoint, or another pressure defined by the system 310.

System 310 is designed to refuel an aircraft in a cascade architecture. In one embodiment, after the refueling process is completed, several of the storage banks 350 may be at or near a minimum pressure to drive the pressure delta (typically 350 bar). The next refueling process requires a pressure above 350 bar and below 500 bar. The H₂ from the storage banks 350 at or below 350 bar will then be consolidated to one or more of the banks 350 to allow the pressure within the storage bank 350 to exceed the pressure needed to refuel the aircraft, e.g., P (MSD)>P (aircraft), therefore allowing the aircraft to refuel via a delta in pressure.

During the refueling process, the gas remaining in a storage bank 350 may reach a pressure that is less than the required pressure of 350 bar to refill the aircraft, as measured by a pressure sensor. Therefore, the booster 340 is activated to compress the H₂ from one storage bank 350, in this example, from a minimum of 250 bar to 500 bar into another bank. This repressurized by the booster 340 acts to consolidate some or all of the remaining H₂ in storage banks 350 into one or more of the storage banks 350. This results in a compression ratio that is not possible by utilizing the compressor alone. The system 310 may then discharge into the aircraft.

In order to even out bank utilization, the MSD may be operated in a manner that distributes charge-discharge cycles and uses three storage banks, with one storage bank 350 as a swing storage bank 350 that offers intermediate pressure. However, any number of storage banks 350 being used in any manner may be possible, as may be dependent on the design of the system 310.

In one example, for the system 310 to operate effectively, it is desirable for the compression system to run in a configuration that includes a compressor 330 to allow flow rates at high compression ratios (20:1) while having a booster 340 to allow a lower range of pressure on the suction side. Alternate pressure ratio compressors may be utilized so long as the product of the inlet pressure, multiplied by the pressure ratio of the compressor 330 multiplied by the pressure ratio of the booster 340, is above the final max storage pressure (Pi*Cp1*Cp2≥Pf). In one embodiment, Pi is 20 bar and Pf is 500 bar. This leads to a simplified mode of force described in the table in Table 1 below.

TABLE 1
Simplified mode of force

| Inlet Pressure | Mode of force | Order of operations |
|---|---|---|
| <20 bar | Below compressor min | N/A |
| | suction pressure | |
| 20 bar < Pᵢₙₗₑₜ < 40 bar | Compressor + booster | 2 |
| 40 bar < Pᵢₙₗₑₜ < 280 bar | Pressure Regulator + | 4 |
| | Compressor | |
| 280 bar < Pᵢₙₗₑₜ < P_{storage} | Booster | 3 |
| P_{mawp} > Pᵢₙₗₑₜ > P_{storage} | Pressure Delta | 1 |

Within system 310, the H₂ inlet system monitors and controls the H₂ flow to the storage systems. In one example, the user is able to select which bank to fill and the source of the H₂ (external or internal bank); the controls must be able to manage compressor engagement vs. bypass and operate all Automatic Opening Vent (AOVs) systems associated with the H₂ movement. The system 310 will be expected to fill from H₂ sources between 20 bar_{g} and 500 bar_{g} and autonomously determine if Pᵢₙₗₑₜ is greater than P_{storage} to bypass the compressor system. Alternatively, if P_{storage} is greater than Pᵢₙₗₑₜ and Pᵢₙₗₑₜ is below 40 bar_{g}, then the compressor system will be utilized. If the inlet pressure is greater than 40 bar_{g} and lower than the minimum suction pressure required to achieve a booster discharge pressure of P_{final} (a minimum booster suction pressure of 280 bar_{g} given a cP ratio of 1.8 and a final target pressure of 500 bar in this configuration), then the booster will be utilized until P_{storage} is equal to P_{final}. This process may follow the order of operations, per Table 1. If the inlet pressure is greater than 40 bar_{g} and lower than P_{storage}, then the booster compressor will be utilized, as shown in Table 1.

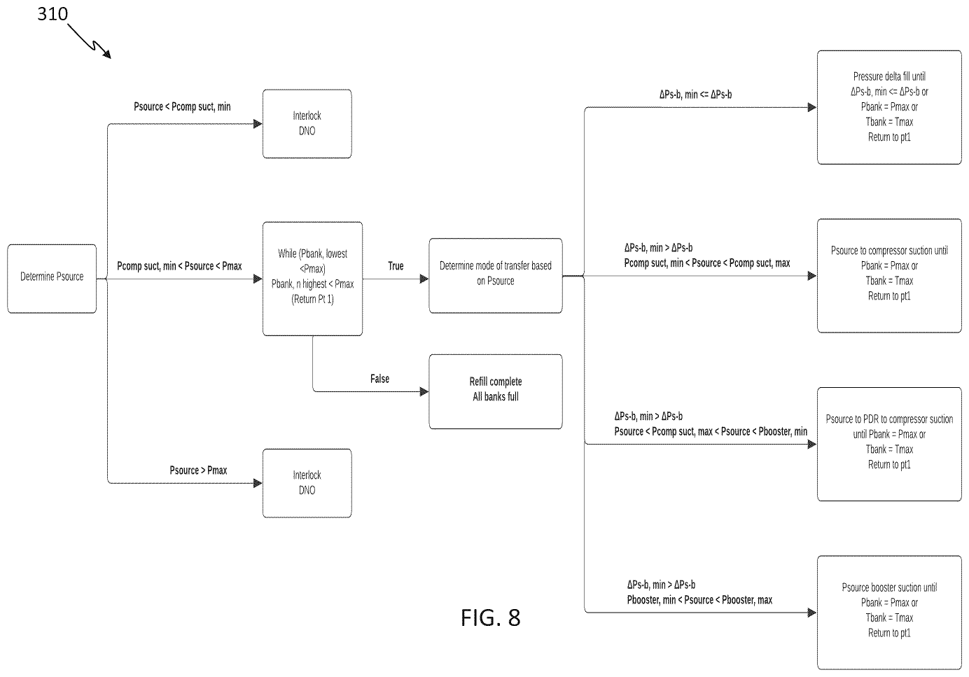

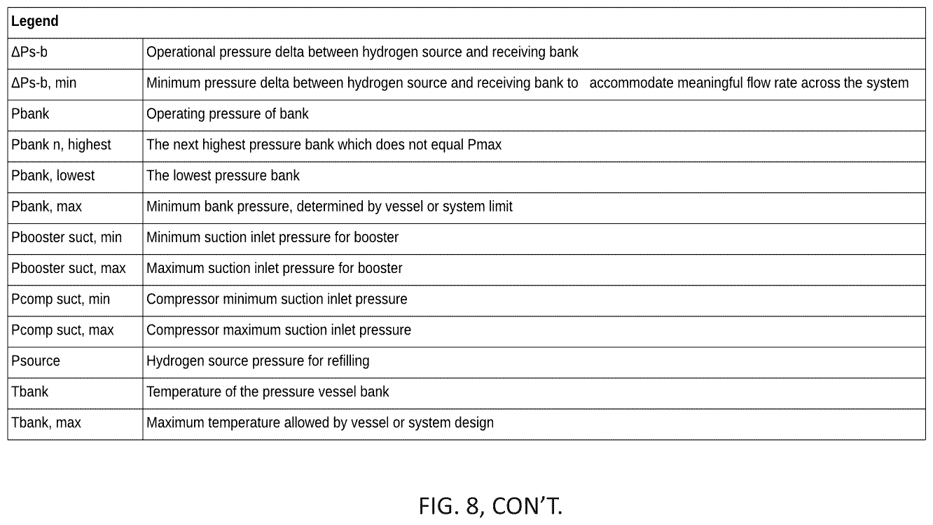

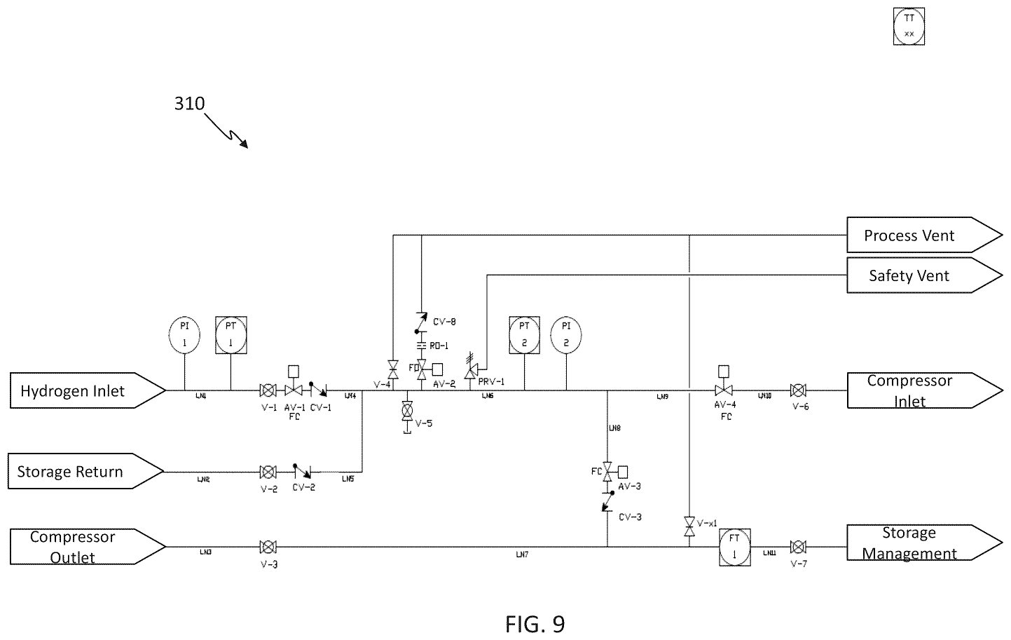

FIG. 8 is a flow diagram illustration of process logic of the mobile storage and dispensing system 310 for refueling H₂-powered vehicles, in accordance with the present disclosure, and FIG. 9 is a schematic illustration illustrating details of a manifold and inputs of the mobile storage and dispensing system for refueling H₂-powered vehicles, in accordance with the present disclosure. The system 310 will prioritize filling via pressure delta first to the bank with the highest pressure to maximize the pressure delta from the inlet source. The implicit assumption is that the pressure source loading the system 310 is not infinite; therefore, it is important to prioritize the highest-pressure bank as the first fill, followed by the next highest pressure bank, and so on. This process is depicted in the flow diagram logic in FIG. 8.

The control system may be implemented via a series of PLCs (programmable logic controllers), with safety systems having dry relays to avoid any risk of computational failure, as is standard practice. The PLCs have Input/Output commands communicated via standard MODBUS protocols or via a MQTT protocol.

The manifolding logic optimizes energy usage of the compressor system by routing the inlet gas to the correct compressor/booster stage, minimizing the pressure letdown across a pressure regulator. This is depicted in FIG. 7. Depending on the source pressure of H₂ (either from a system external to the refueller or another bank), the control logic will bypass the appropriate compressor stages via the valves on the manifold panel and deactivate compressor stages that are not active either by cams or clutches, limiting parasitic losses on the compressor motor.

The H₂ transfer system include the booster 340 compressor which is able to transfer H₂ between the internal cylinder banks, from low pressure to high pressure banks, which allows the system 310 to increase the pressure of a bank to the operational limit (500 bar_{g}) to “top up” aircraft near their operational pressure limit of 350 bar_{g}. Additionally, it allows the MSD to de-inventory banks (to 20 bar_{g}) before venting to atmospheric pressure for maintenance.

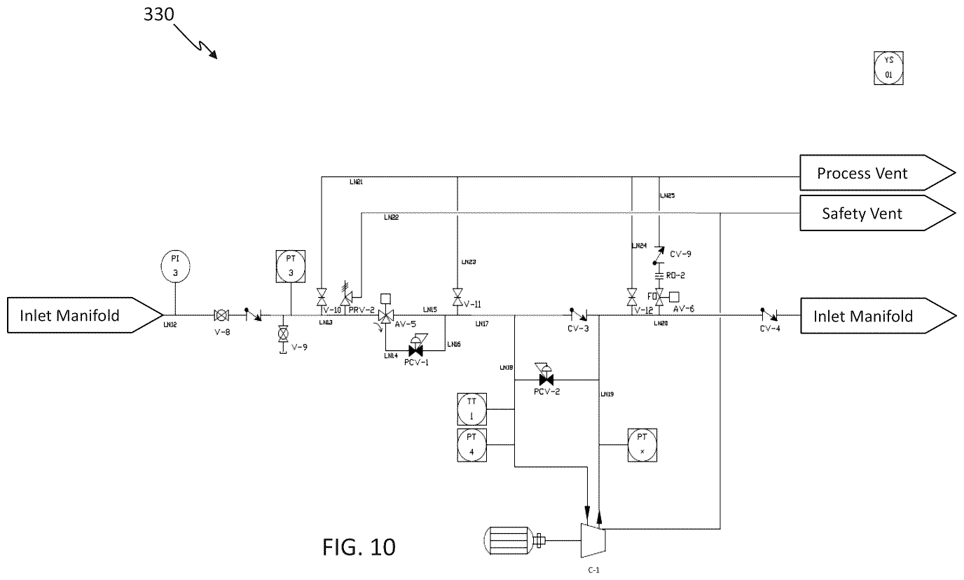

FIG. 10 is a schematic illustration illustrating details of a compressor system 330 of the mobile storage and dispensing system 310 for refueling H₂-powered vehicles, in accordance with the present disclosure. The compressor system 330 is only activated if the inlet pressure is lower than the destination tank pressure. The compressor suction pressure will be bound from 20 bar_{g} to 500 bar_{g}, and the outlet pressure will also be 20 bar_{g} to 500 bar_{g}. In one example the compressor must be able to compress H₂ from a feed source outside of the MSD boundary limits and between internal banks for H₂ transfer. The maximum working pressure on the inlet side of the compressor may be rated lower than the H₂ inlet pressure; it is therefore important to have a pressure controller with an open bypass, with the former being the “default” route, allowing for a pressure-controlled inlet, but unrestricted flow when the inlet pressures are low. Thermal limitations of type 4 cylinders are assumed to be the critical limit to control compression and transfer rates. The minimum compression must not be significantly lower than thermodynamics allow (cannot be

$${\frac{\partial q}{\partial t}}_{compressor limit} ≪ {\frac{\partial q}{\partial t}}_{thermal limitation} ) .$$

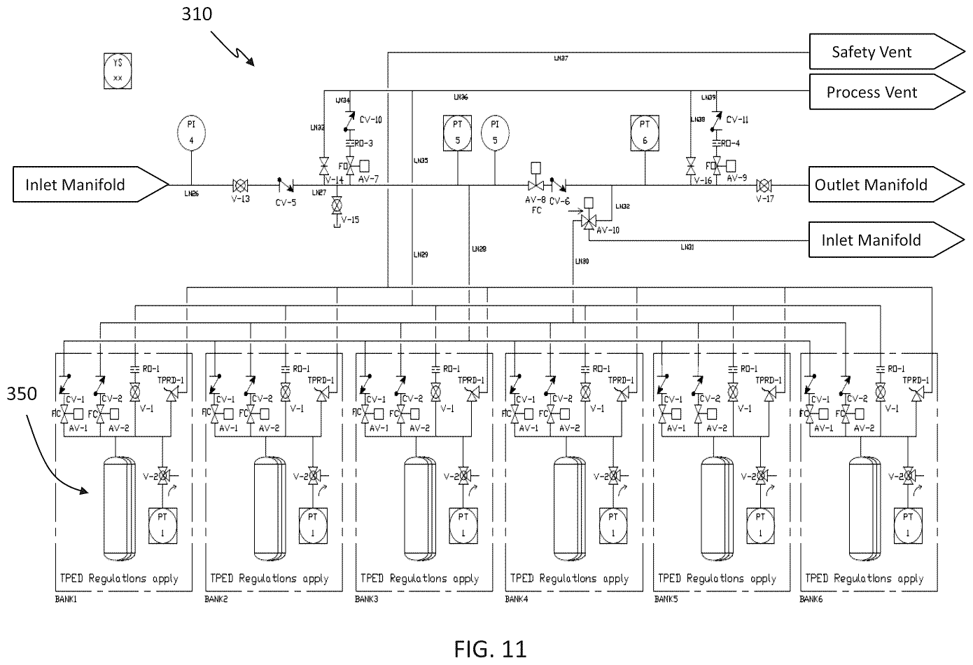

FIG. 11 is a schematic illustration illustrating details of a H₂ storage system using banks 350 of the mobile storage and dispensing system 310 for refueling H₂-powered vehicles, in accordance with the present disclosure. As shown, the storage system may control the inlet and outlet of gas to and from the storage tanks within banks 350. The tanks are split into 9 functional groups or banks to allow for cascade filling. This system typically directs gas towards the H₂ outlet system to assist in vehicle fills or other external applications, if necessary. Additionally, the system may direct gas towards the H₂ Inlet System to be able to redistribute gas between tanks.

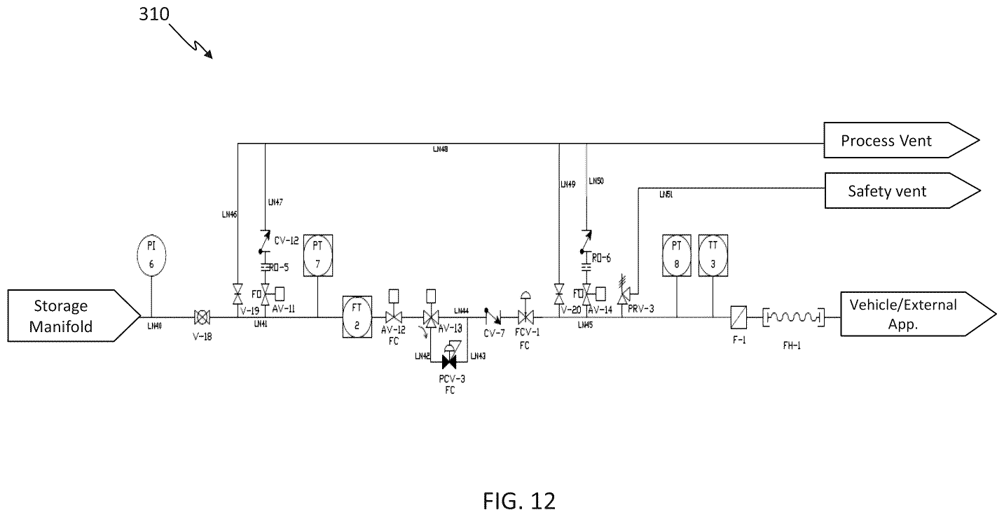

FIG. 12 is a schematic illustration illustrating details of a H₂ outlet system of the mobile storage and dispensing system 310 for refueling H₂-powered vehicles, in accordance with the present disclosure. As shown, the H₂ outlet system regulates the flow from the storage tanks to the external application, such as vehicles. Typically, this unit would regulate flow as per SAE J2601/J2601⁻² or, where applicable under an engineering mode, to static applications.

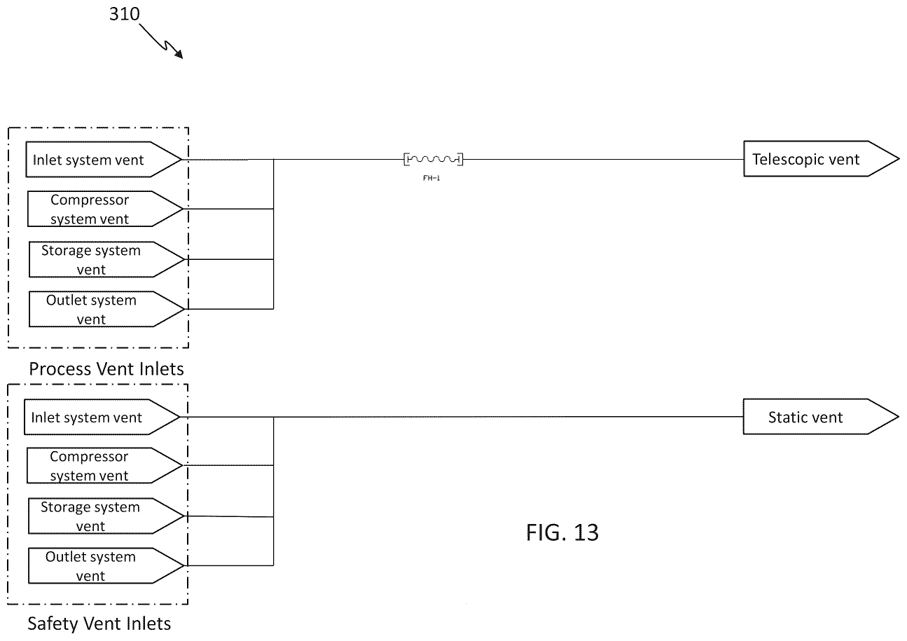

FIG. 13 is a schematic illustration illustrating details of a venting system of the mobile storage and dispensing system 310 for refueling H₂-powered vehicles, in accordance with the present disclosure. The venting system as shown in FIG. 13 consists of a general process vent, which is used during purging of inlet/outlet piping or MSD internal manifolding, and a safety vent. The process vent is a controlled release point which allows regular venting, such as during pressure hold tests, automated purging, and pipework depressurization. This vent will be utilized frequently in routine operations and is expected to generate an external Zone 1, which is limited in its zone extents by controlling the overall release. The safety vent is a static vent with an outlet located around the same plane as the top of the MSD vehicle.

Variations to system 310 may exist. For instance, different tank sizes per storage bank may be used to improve or to minimize the number of pressure transfer events within each storage bank. Tank sizes or an increase in the storage volume of the cylinders are increased such that each bank is at a minimum only 1 tank, leading to decreases in the complexity of the system and leak potential. Larger storage volume per storage banks will reduce how often pressure consolidation/transfer events are required.

Pressure relief/pressure reduction valving may be added to reduce energy losses within the system. Additional pressure reducing valves step down the pressure to the minimum amount required to be fed into each interstage inlet for the multistage compressor.

A better partitioned compressor may be used to minimize energy consumption, higher compression ratio, and outlet pressure. Inlets to the compressor interstages minimize the pressure letdown required before feeding directly to the compressor 1^{st} stage or booster. Alternatively, single stage compressors with valving to duct gas to the correct compressor while bypassing the lower pressure stages would reduce the amount of pressure letdown required.

FC derived power for the compressor may be added in order to be a fully isolated system. A slip stream of the stored H₂ may be taken to generate power via an onboard FC, removing the need for a shore power connection.

A single reducing orifice downstream of the pressure storage may be used to ensure the max flow rate does not exceed J2601 protocol of 60 g/s. A variable reducing orifice valve or globe valve with a Cv specifically designed for gaseous H₂ service could ensure that the reducing orifice does not limit the flow rate unnecessarily when the dP decreases as the pressure bank equilibrates to the receiving vehicle. A variable reducing orifice valve or globe valve with a Cv specifically designed for gaseous H₂ service to vary with respect to the dP of the H₂ could ensure that the reducing orifice does not limit the flow rate unnecessarily as the dP decreases and the pressure bank equilibrates to the receiving vehicle. In one of many alternatives, an array of several reducing orifices with isolation valves and control logic could automatically select the correct orifice, depending on the dP, to more achieve flow rates near the 60 g/s protocol limit.

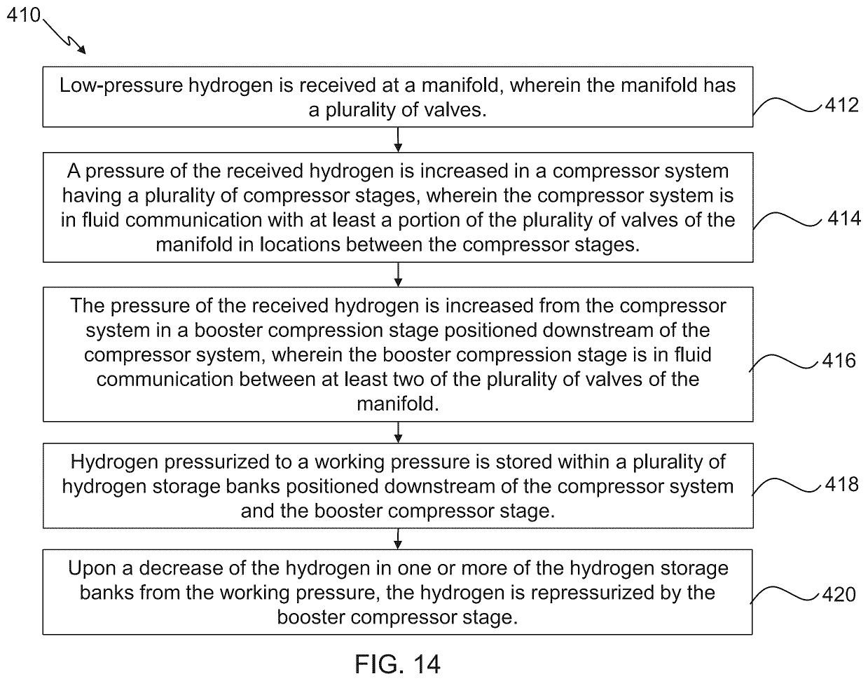

FIG. 14 is a flowchart 410 illustrating a detailed method of refueling H₂-powered vehicles with a mobile storage and dispensing system, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 412, low-pressure H₂ is received at a manifold, wherein the manifold has a plurality of valves. A pressure of the received H₂ is increased in a compressor system having a plurality of compressor stages, wherein the compressor system is in fluid communication with at least a portion of the plurality of valves of the manifold in locations between the compressor stages (block 414). The pressure of the received H₂ is increased from the compressor system in a booster compression stage positioned downstream of the compressor system, wherein the booster compression stage is in fluid communication between at least two of the plurality of valves of the manifold (block 416). H₂ pressurized to a working pressure is stored within a plurality of H₂ storage banks positioned downstream of the compressor system and the booster compressor stage (block 418). Upon a decrease of the H₂ in one or more of the H₂ storage banks from the working pressure, the H₂ is repressurized by the booster compressor stage (block 420). Any number of additional steps, functions, processes, or variants thereof may be included in the method, including any disclosed relative to any other figure of this disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

10 system
20 inner chamber
22 outside wall
30 outer chamber
32 interior volume
40 NEG device
50 layers
110-134 flowchart and blocks
210-234 flowchart and blocks
250 truck
252 rail car
254 ship
302 H₂ source
310 system
320 manifold
330 compressor
332A-332C compressor stages
340 booster compression stage
350 H₂ storage bank
410-420 flowchart and blocks

What is claimed is:

1. A method of manufacturing a ground-based cryogenic tank for storing hydrogen (H₂), the method comprising:
bonding an activated carbon to an outside wall of an inner chamber;
bake-out conditioning at least the inner chamber;
after the inner chamber is positioned within an outer chamber, generating a vacuum within an interior volume of the outer chamber; and
passive pumping the interior volume with at least one non-evaporable getter (NEG).

2. The method of claim 1, wherein the inner chamber is formed from aluminum, further comprising conversion coating the aluminum, wherein the conversion coating preferably comprises a trivalent chromium liquid coating applied by dipping, wiping or spraying.

3. A ground-based cryogenic tank system for storing hydrogen (H₂) comprising:
an inner chamber configured for storing H₂ in a liquid state;
an activated carbon bonded to an outside wall of at least the inner chamber, wherein at least the inner chamber is bake-out conditioned;
an outer chamber having an interior volume, wherein the inner chamber is positioned within the interior volume, wherein a vacuum exists in the interior volume; and
at least one non-evaporable getter (NEG) for passive pumping of the interior volume.

4. The system of claim 3, wherein the inner chamber is formed from aluminum, wherein the aluminum is conversion coated, wherein the aluminum preferably is conversion coated by a trivalent chromium liquid coating applied by dipping, wiping or spraying.

5. The system of claim 3, wherein the tank system is stationary, or is carried on a truck, or a rail car, on a ship.

6. A method of manufacturing a ground-based cryogenic tank for storing hydrogen (H₂), the method comprising:
manufacturing an inner chamber from aluminum;
manufacturing an outer chamber having an interior volume;
conversion coating at least the aluminum of the inner chamber;
bonding an activated carbon to an outside wall of the inner chamber;
bake-out conditioning the inner and outer chambers;
positioning the inner chamber within an interior volume of an outer chamber;
generating a vacuum within the interior volume of the outer chamber; and
passive pumping the interior volume with at least one non-evaporable getter (NEG).

7. The method of claim 6, wherein the conversion coating comprises a trivalent chromium liquid coating applied by dipping, wiping, or spraying.

8. A mobile storage and dispensing system for refueling hydrogen (H₂)-powered vehicles, the system comprising:
a manifold configured to receive H₂, wherein the manifold has a plurality of valves;
a compressor system having a plurality of compressor stages, wherein the compressor system is in fluid communication with at least a portion of the plurality of valves of the manifold in locations between the compressor stages;
a booster compression stage positioned downstream of the compressor system and in fluid communication between at least two of the plurality of valves of the manifold; and
a plurality of H₂ storage banks positioned downstream of the compressor system and the booster compressor stage,
wherein low-pressure H₂ is pressurized by at least one of the compressor system or the booster compressor stage to a working pressure and stored within one or more of the H₂ storage banks, and wherein, upon a decrease of the H₂ in one or more of the H₂ storage banks from the working pressure, the H₂ is repressurized by the booster compressor stage.

9. The system of claim 8, wherein the plurality of H₂ storage banks are sized to carry substantially 1000 kg of H₂.

10. The system of claim 8, wherein the H₂ is repressurized by the booster compressor stage and consolidated into one or more of the H₂ storage banks.

11. The system of claim 8, wherein the H₂ received at the manifold is substantially 20 bar, and wherein the working pressure of the H₂ is greater than 350 bar.

12. The system of claim 8, wherein a pressure of the H₂ in the compressor system is substantially 400 bar, and the pressure of the H₂ in the booster compression stage is substantially 720 bar.

13. The system of claim 8, wherein at least one pressure sensor positioned to sense a pressure of H₂ in the plurality of H₂ storage banks.

14. The system of claim 8, wherein the plurality of H₂ storage banks further comprises at least three H₂ storage banks, wherein the three H₂ storage banks are operated to distribute charge-discharge cycles with one of the H₂ storage banks being a swing bank providing intermediate pressure.

15. The system of claim 8, wherein the manifold is inlet pressure agnostic.

16. The system of claim 8, wherein the H₂ storage banks further comprise different H₂ tank sizes.

17. The system of claim 8, wherein the manifold optimizes energy usage of the compressor system and booster compression stage by routing inlet H₂ gas to a particular compressor stage or the booster compression stage, thereby minimizing a pressure letdown across a pressure regulator.

18. A method of refueling hydrogen (H₂)-powered vehicles with a mobile storage and dispensing system, the method comprising:
receiving low-pressure H₂ at a manifold, wherein the manifold has a plurality of valves;
increasing a pressure of the received H₂ in a compressor system having a plurality of compressor stages, wherein the compressor system is in fluid communication with at least a portion of the plurality of valves of the manifold in locations between the compressor stages;
increasing the pressure of the received H₂ from the compressor system in a booster compression stage positioned downstream of the compressor system, wherein the booster compression stage is in fluid communication between at least two of the plurality of valves of the manifold; and
storing H₂ pressurized to a working pressure within a plurality of H₂ storage banks positioned downstream of the compressor system and the booster compressor stage,
whereby, upon a decrease of the H₂ in one or more of the H₂ storage banks from the working pressure, the H₂ is repressurized by the booster compressor stage.

19. The method of claim 18, wherein the plurality of H₂ storage banks are sized to carry substantially 1000 kg of H₂.

20. The method of claim 18, wherein repressurization of the H₂ by the booster compressor stage further comprises consolidation of the H₂ into one or more of the H₂ storage banks.

21. The method of claim 18, wherein the H₂ received at the manifold is substantially 20 bar, and wherein the working pressure of the H₂ is greater than 350 bar.

22. The method of claim 18, wherein the pressure of the H₂ in the compressor system is substantially 400 bar, and the pressure of the H₂ in the booster compression stage is substantially 720 bar.

23. The method of claim 18, further comprising sensing the pressure of H₂ in the plurality of H₂ storage banks with at least one pressure sensor.

24. The method of claim 18, wherein the plurality of H₂ storage banks further comprises at least three H₂ storage banks, further comprising operating the three H₂ storage banks to distribute charge-discharge cycles with one of the H₂ storage banks being a swing bank providing intermediate pressure.

25. The method of claim 18, wherein the manifold is inlet pressure agnostic.

26. The method of claim 18, wherein the H₂ storage banks further comprise different H₂ tank sizes.

27. The method of claim 18, further comprising optimizing energy usage of the compressor system and booster compression stage, by the manifold, by routing inlet H₂ gas to a particular compressor stage or the booster compression stage, thereby minimizing a pressure letdown across a pressure regulator.

28. The method of claim 18, wherein the vehicle is selected from the group consisting of a land based vehicle, a water based vehicle and a flying vehicle.

29. The method of claim 28, wherein the flying vehicle is selected from the group consisting of a winged airplane, a helicopter or a rocket.
